(19) United States
(12) Patent Application Publication
(10) Pub. No.: US 2016/0335331 A1
(43) Pub. Date: Nov. 17, 2016

(54) SYSTEM AND METHOD FOR PROVIDING CLIMATE DATA ANALYTICS AS A SERVICE

(71) Applicant: U.S.A. represented by the Administrator of the National Aeronautics and Space Administration, Washington, DC (US)

(72) Inventors: John L. Schnase, Laurel, MD (US); Daniel Q. Duffy, Gambrills, MD (US); Glenn S. Tamkin, Silver Spring, MD (US)

(21) Appl. No.: 14/711,476

(22) Filed: May 13, 2015

(51) Int. Cl. G06F 17/30; G01W 1/00

(52) U.S. Cl. CPC G06F 17/30563; G06F 17/30914; G01W 1/00

(57) ABSTRACT

A system, method and computer-readable storage devices for providing climate data analytics as a service. An example system can include a high-performance data analytics platform that provides a compute-storage fabric, a high-performance file system, and a virtualizer. The system can include an analytic service that transforms multidimensional binary climate data to yield analysis files formatted for high-performance analytic software input and output, that transforms analysis files to yield multidimensional binary files encoded in a commonly used climate data file format, and that performs high-performance analytic operations over analysis files stored in the high-performance files system and collects results into dynamically created data objects.. The system can also provide a persistence service and a system interface. The persistence service can store and manage the data objects, and can deploy climate data server instances as virtual climate data servers in a federated data grid.

### BACKGROUND

1. Technical Field

The present disclosure relates to data analytic services and more specifically to providing access to large sets of climate data via a data analytics service.

2. Introduction

Climate models generate data that are of great value to society. Climate model outputs include retrospective analyses that model the historical state of the climate, estimates of current climate conditions, and projections of future climate conditions. Currently the ability of end users, applications, climate researchers, or members of the public to gain meaningful access to climate model data is limited. The current technologies are deficient because the data sets generated by climate models are too large to be moved from the archives where they are stored to end users where the data are typically analyzed and used. What is needed is an improved approach that makes it easier to access the data and perform data analyses where the data are stored before moving reduced, more usable products to the end user for further study.

### BRIEF DESCRIPTION OF THE DRAWINGS

FIG. 1 illustrates an example of a climate data analytics system;

FIG. 2 illustrates details of an example analytic service;

FIG. 3 illustrates details of an example persistence service;

FIG. 4 illustrates an example use scenario and flow diagram of an analytic service;

FIG. 5 illustrates an example use scenario and flow diagram of a climate data analytics system;

FIG. 6 illustrates an example method embodiment; and

FIG. 7 illustrates an example system embodiment.

### DETAILED DESCRIPTION

A system, method and computer-readable storage devices are disclosed which deliver climate data analytics as a service via a combination of technologies.

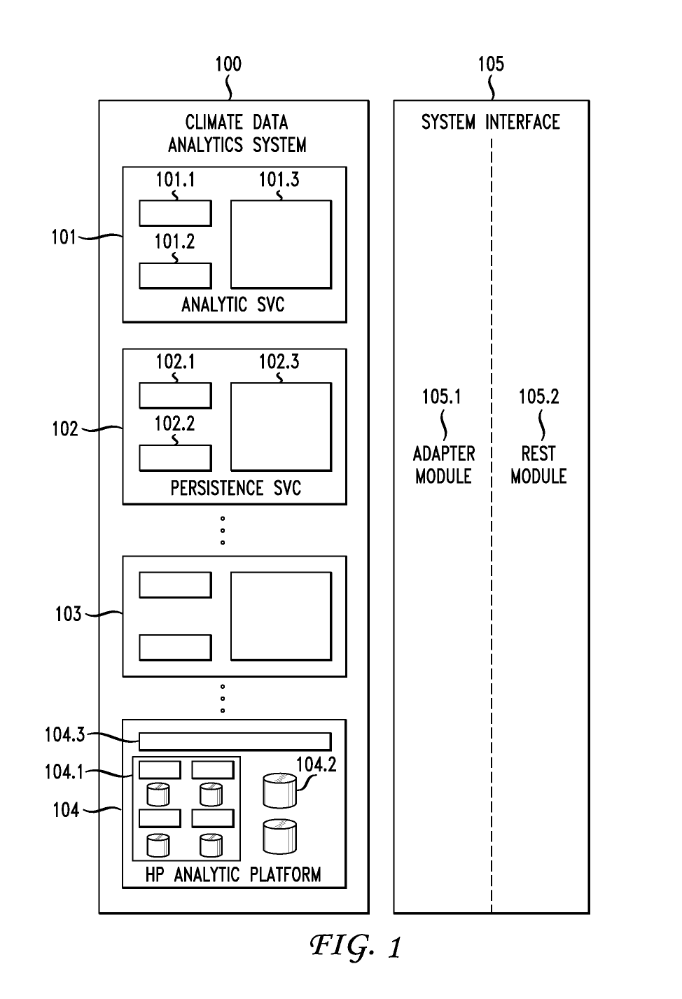

FIG. 1 illustrates an example climate data analytics system 100. In some embodiments, the system 100 includes a high-performance data analytics platform 104, at a minimum two required services, an analytic service 101, a persistence service 102, and a system interface 105. In one embodiment, the data analytics platform is a storage cluster 104.1, high-performance file system 104.2, and virtualization software 104.3 that allows the capabilities of the storage platform to be quickly tailored and deployed for specific purposes. The architecture of the storage cluster can vary, but it basically provides the high-performance compute-storage “fabric” upon which the analytic system runs. Generally associated with the storage cluster is a high-performance file system that can be integrated in various ways to additionally support the activities of the system and provide the option of alternative storage configurations for alternative analytic approaches. The capacity to virtualize the capabilities of the system make the overall compute-storage resource an agile environment that is capable of being configured in any number of ways to accommodate particular needs and particular analytic approaches.

In one embodiment, the analytic service 101 is a program 101.1 that transforms multidimensional binary climate data files from the formats that are commonly used as outputs from numerical climate models to yield analysis files in formats that are optimized for use by high-performance analytics software. This program can further load the analysis files into the high-performance storage systems of the associated data analytics platform. The service may also contain a complementary program 101.2 that does the reverse: transforms analysis files stored in the data analytics platform to yield multidimensional binary files encoded in a commonly used climate data file format and moves the transformed files out of the high-performance file system of the analytics platform. The analytics service 101 can include other programs or components 101.3 for executing related functions.

The analytic service can include a collection of analytic programs 101.3 that implement the core functionality of the service. As described in more detail below, these programs are typically designed to perform parallel operations that exploit the high-performance computing capabilities of the data analytics platform.

In one embodiment, the system includes a persistence service 102 that contains a climate data server 102.3 that stores and manages the data objects created by the analytic service, virtualization and provisioning software 102.2 that allows multiple climate data server instances to be deployed as virtual climate data servers, and software 102.1 that allows multiple virtual climate data servers to be linked into a federated data grid. The climate data server can be specialized for use with climate data and performs the traditional functions of collections-building, managing, querying, and accessing data, as well as applying and enforcing policy-based controls and rich metadata management required for long-term digital preservation. It functions as a full-featured archive management system. The capacity to create multiple instances of the climate data server and federate them into meaningful collections of servers conveys to the system a high level of tailorability whereby the particular needs of users or applications can be accommodated.

The big data challenges of the climate sciences are often approached from one of two perspectives. They are sometimes viewed as a problem of large-scale data management wherein solutions are offered through an array of traditional storage and archive theory and technologies. These approaches tend to view the big data challenge as one of storing and managing large amounts of structured data for the purpose of being able to find data of interest for particular applications. Alternatively, the big data problem is sometimes viewed as a knowledge management problem wherein solutions are offered through an array of analytical theory and technologies. These approaches tend to view the big data challenge as one of extracting meaningful patterns from large amounts of unstructured data in order to find data of particular interest.

The system disclosed herein brings together in one coherent system the capabilities of an analytic service and a persistence service. The climate data analytics system provides the technology framework for dealing with the big data challenges of the climate sciences from both perspectives. The system treats interactions with the data analytics system as though they were the interactions a user or application might have with an archive system, in particular an archive that is specialized for the long-term preservation of digital scientific data. The system also treats the data objects that are generated by the analytic system as objects within the archive, specifically as dynamically created (realizable) objects of the archive that have no real existence until they are computed. That is why the example climate data analytics system has two core services: an analytic service and a persistence service.

In one embodiment, the climate data analytics system can also include additional services 103 that contribute to the overall usability of the system. These services augment the capabilities of the system by transforming the data objects generated by the analytic service or persisted by the persistence service to yield data objects tailored to the specific requirements of the end user. Examples of additional services include regridding services, downscaling services, and formatting services. This collection of support services can of course expand as needed to meet customer needs.

An important class of additional services is a discovery service that allows users to find out information about the data objects that can be computed by the analytic service or data objects that have been stored in the persistence service. Searching for existing objects in the persistence service follows the traditional pattern of matching the metadata associated with objects with search criteria provided by the user. Object discovery in the analytic service behaves differently. Since discoverable objects do not come into existence until they are requested, discovery becomes a matter of knowing whether or not the analytic service can compute the object. Thus, if a data object is computable by the analytic service, then asking if an object exists can actually mean asking the service to create the object.

In this way, the archive becomes dynamic, accommodating unanticipated applications of the data on an as-needed basis. Given sufficient computational resources, the system can create virtual collections of special interest that have no real existence or corresponding storage and management requirements. This stands in contrast to previous systems, which create multiple specialized collections to satisfy multiple varying needs, thereby contributing to the big data problem rather than solving it.

Returning to the overall architecture of the system, the example climate data analytics system can include an interface that exposes the capabilities of the system to users and applications. The system interface 105 can include an adapter module 105.1 that invokes climate data analytics system services by mapping service requests from the outside to specific operations in the system services suite, and a communications module 105.2 that links the adapter module to external applications through a service request protocol based on the data flow categories of a long-term preservation digital archive reference model. By restricting the communications protocol to the interactions defined by an archive reference model, the climate data analytics system as a whole takes on the appearance of a dynamic archival information system capable of performing full information lifecycle management in an analytics context. Existing archive systems will find it easier to integrate the system, because the interfaces and interactions with the system will be familiar to the archive authorities and existing archive systems, and the behaviors implemented by the climate data analytics system can be organized around traditional archive operations workflows.

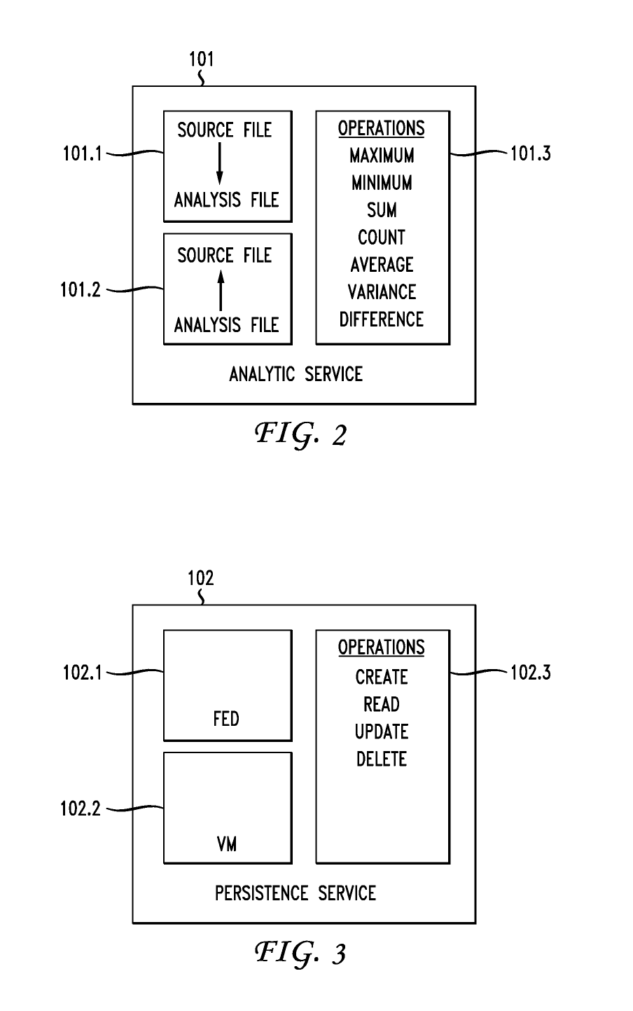

FIG. 2 illustrates components of the analytic service 101 in greater detail. As described above, the analytic service 101 includes a collection of analytic programs 101.3 that implement the core functionality of the service. These programs are typically designed to perform parallel operations that exploit the high-performance computing capabilities of the data analytics platform. Climate data can be a collection of variables whose values in the aggregate characterize the state of Earth's atmosphere at a given time and place. As a result, operations over climate data typically require at a minimum inputs that specify the name of the climate variable of interest, a spatial extent specifying the area of interest, and a temporal extent specifying a time span of interest. Depending on the nature of the operation to be performed, other parameters may also be required or provided. Data-intensive analysis workflows, in general, bridge between a largely unstructured mass of archived scientific data and the highly structured, tailored, reduced, and refined analytic products that are used by individual scientists and form the basis of intellectual work in the domain. In general, the initial steps of an analysis, those operations that first interact with a data repository, tend to be the most general, while data manipulations closer to the client tend to be the most specialized to the individual, to the domain, or to the science question under study. The amount of data being operated on also tends to be larger on the repository-side of the workflow, smaller toward the client-side end products.

This stratification can be exploited in order to optimize efficiencies along the workflow chain. A climate data analytics system can implement a set of near-archive, early-stage analytical operations that represent a common starting point in many analysis workflows in many domains. For example, average, variance, maximum, minimum, sum, count, and difference operations of the general form:

result<=avg(var, (t0,t1), ((x0,y0,z0),(x1,y1,z1)))

that return, in this example, the average value of a variable when given its name, a temporal extent, and a spatial extent. Because of their widespread use, these simple operations can be referred to as “canonical ops” with which more complex analytic expressions can be built. If the high-performance data analytics platform is viewed as a specialized type of computer, a climate computer, then the canonical operations can be viewed as the instructions set, or assembly language, for the climate computer.

By virtue of implementing the simple canonical operations in a high-performance compute-storage environment using sophisticated analytical software, the system 100 is also able to support more complex analyses, such as the predictive modeling, machine learning, and neural networking approaches often associated with advanced analytics.

FIG. 3 illustrates major components of the persistence service 102. In one embodiment, the persistence service 102 supports operations that perform the classic “CRUD” operations of an archive: create, read, update, and delete data objects and metadata associated with the data objects.

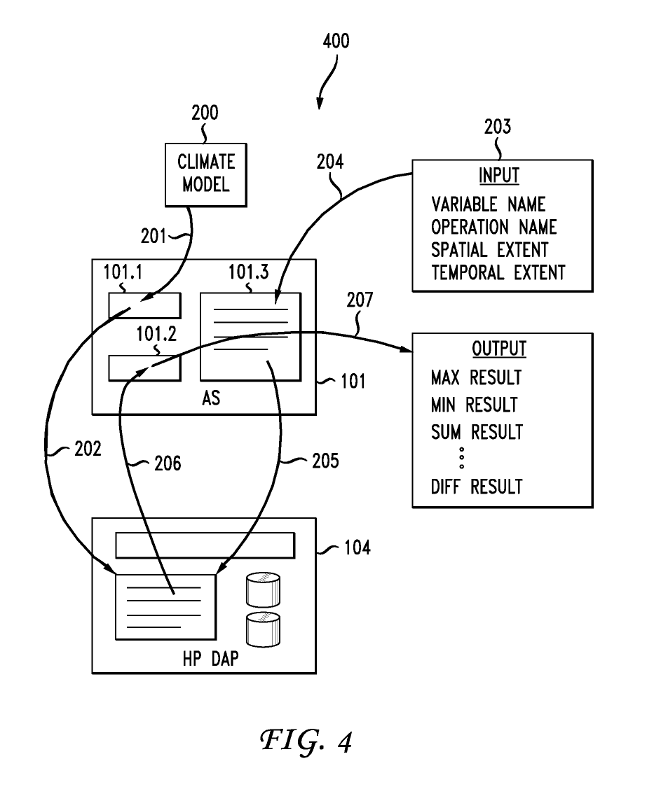

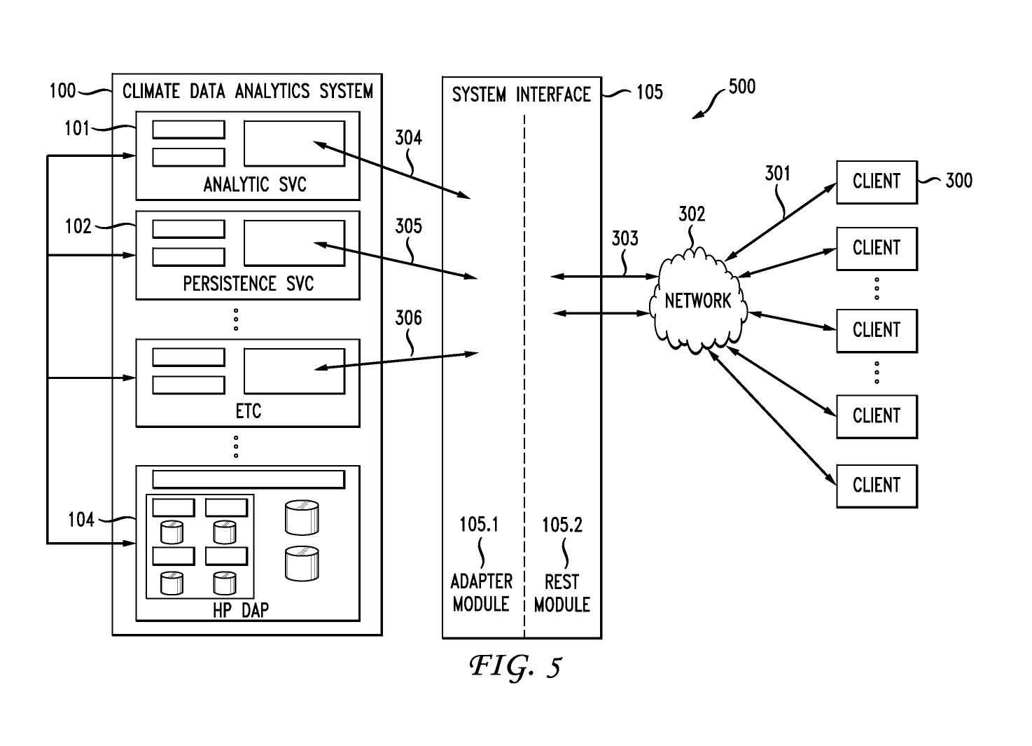

FIG. 4 illustrates the basic patterns of interaction among the major components of an analytic service. In a first step, the data output from a climate model 201 is input into software that transforms the data 101.1 to yield analysis files that can be operated upon by the analytic service. These analysis files are loaded into the storage-compute system of the data analytics platform 202. Once the data collection is built, it can be operated upon by the functions implemented by the analytic service.

The functions of the service are invoked with the required parameters 204, which are provided as input to the service 203. The operations themselves run on the analytic platform 205, which produces results that are passed to software that transforms the results into file formats commonly used by end users and applications 206 and transfers the results to the calling application 207. A similar pattern of interaction would apply to the persistence service; however, the persistence service would use the storage capabilities of the system to store and manage data objects.

FIG. 5 illustrates the overall behavior 500 of a climate data analytics system. In an example use of the system, a user or client application may want to know the projected average summer temperature over North America ten years from now. The climate model data collection supported by the analytic service may contain global hourly values for temperature, the values being computed by the numerical model whose output formed the data collection. Software applications running on client devices 300 would connect 301 through a network 302 to the climate data analytics system interface 105 to gain access to the capabilities of the system. In this example, the service request 303 would specify the variable of interest (temperature), the spatial and temporal extent of interest (North America and the summer months ten years out), the operation to be performed (average), and the service to perform the operation (analytic service). The system interface 105 would map the service request to the analytic service 101, which would calculate the requested result as described above in FIG. 4. The calculated result would then be returned through the system interface 105 to the requesting application, i.e. one of the clients 300, whereupon the application may issue a service request to the persistence service 102 to store and manage the newly created object. The full complement of capabilities afforded by the services supported by climate data analytics system would be accessed in a similar fashion.

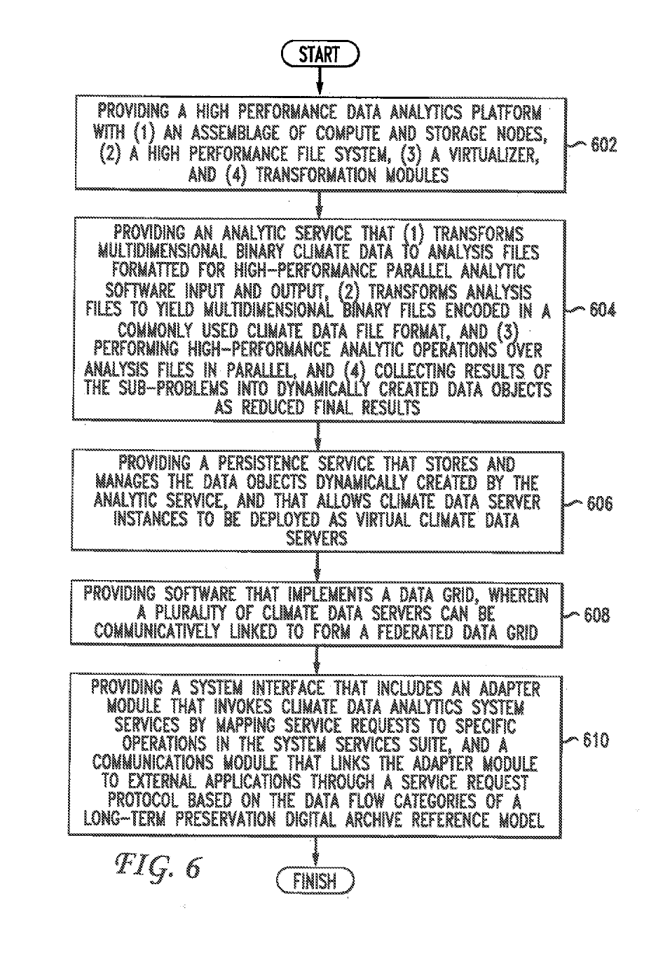

Having disclosed some basic system components and concepts, the disclosure now turns to the exemplary method embodiment shown in FIG. 6. For the sake of clarity, the method is described in terms of an exemplary system 500 as shown in FIG. 5 configured to practice the method. The steps outlined herein are exemplary and can be implemented in any combination thereof, including combinations that exclude, add, or modify certain steps.

A system 500 configured according to this disclosure can include a high-performance data analytics platform (602) that has an assemblage of compute and storage nodes that provide a compute-storage fabric upon which high-performance analytic operations are performed over distributed collections of climate data, a high-performance file system, and a virtualizer that virtualizes the high-performance data analytics platform for customized deployment of the high-performance data analytics platform.

The system can include an analytic service (604) that has a first module that transforms multidimensional binary climate data encoded in a commonly used climate data file format to yield analysis files suitably formatted for analytic software input and output and loads the transformed files into the file system of the high-performance data analytics platform, a second module that transforms analysis files stored in the high-performance data analytics platform to yield multidimensional binary files encoded in a commonly used climate data file format and moves the transformed files out of the high-performance file system of the high-performance data analytics platform, and a third module including a set of software applications that implement the functions of the service by performing high-performance analytic operations over analysis files stored in the high-performance files system and collecting results into dynamically created data objects. The software applications that implement the functions of the service can accept inputs such as a name of a climate variable contained in a climate data set, a spatial extent that specifies the area of interest for a climate variable, a temporal extent that specifies the time span of interest for a climate variable, and a set of additional parameters as needed by the software applications.

The system can include a persistence service (606) that has a climate data server that stores and manages the data objects dynamically created by the analytic service, virtualization and provisioning software that allows climate data server instances to be deployed as virtual climate data, and software that implements a data grid, wherein a set of climate data servers can be communicatively linked to form a federated data grid. The climate data server can store and manage multidimensional binary data objects from sources other than the analytic service of the climate data analytics system. The climate data server can store and manage data objects in a set of common climate data formats.

The climate data server can also include software (608) that performs data storage functions including collection-building, managing, querying, accessing, and preserving multidimensional binary climate data, software that performs data management functions including applying policy-based control on the data objects stored and managed by the climate data server, logging object-level actions, and managing object-level metadata, and software that performs metadata management functions by extracting the metadata associated with a climate data object and storing the metadata in the climate data server in accordance with the metadata standards of a long-term preservation digital archive reference model. The data storage functions can include a create operation that accepts as input an information package including a multidimensional binary data object and associated metadata, then stores the package in the climate data server, a read operation that transfers an information package stored in the climate data server out of the climate data server, an update operation that modifies an information package stored in the climate data server, and a delete operation that removes an information package from the climate data server.

The system can include a system interface (610) that has an adapter module that invokes climate data analytics system services by mapping service requests to specific operations in the system services suite, and a communications module that links the adapter module to external applications through a service request protocol based on the data flow categories of a long-term preservation digital archive reference model.

The system can optionally include support services that transform analytic service data objects to yield data objects tailored to the specific requirements of the end user. The support services can include a regridding service including software that transforms a data object from one climate grid resolution to yield a data object in a different climate grid resolution, the transformed object further being stored in the persistence service, a downscaling service including software that transforms globally-relevant climate data objects to yield locally-relevant climate data objects, the transformed object further being stored by the persistence service, an ontology service including software that performs ontological alignment over a set of data objects including a heterogeneous and semantically diverse assemblage of variable names, concepts, and metadata representations, the alignment information further being used in subsequent interactions with the system, and a formatting service including software that transforms data objects in one file format to yield data objects in a different file format, the transformed objects further being stored in the persistence service. The support services can be extended to include additional services to meet end user requirements.

The system can optionally include a discovery service wherein a software application provides information about the data objects that can potentially be dynamically generated by the analytic service, the resulting information being used as input in further interactions with the system. The discovery service can further provide information about data objects stored in the persistence service, the resulting information being used as input in further interactions with the system.

The analytic service can provide basic operations such as a maximum operation that determines the maximum value of a climate variable over a specified spatial and temporal extent, a minimum operation that determines the minimum value of a climate variable over a specified spatial and temporal extent, a sum operation that determines the sum of the values of a climate variable over a specified spatial and temporal extent, a count operation that determines the number of instances of a climate variable over a specified spatial and temporal extent, an average operation that determines the arithmetic mean of a set of climate variables over a specified spatial and temporal extent, a variance operation that determines the variance of the mean for a set of a climate variables over a specified spatial and temporal extent, and a difference operation that determines the difference between two climate variables over a specified spatial and temporal extent. These basic operations can be extended to create additional capabilities.

Various embodiments of the disclosure are described in detail below. While specific implementations are described, it should be understood that this is done for illustration purposes only. Other components and configurations may be used without parting from the spirit and scope of the disclosure.

FIG. 6 illustrates an example method embodiment. An example system configured to practice the method can provide a high performance data analytics platform with (1) an assemblage of compute and storage nodes, (2) a high performance file system, (3) a virtualizer, and (4) transformation modules (602). The system can provide an analytic service that (1) transforms multidimensional binary climate data to analysis files formatted for high-performance parallel analytic software input and output, (2) transforms analysis files to yield multidimensional binary files encoded in a commonly used climate data file format, and (3) performing high-performance analytic operations over analysis files in parallel, and (4) collecting results of the sub-problems into dynamically created data objects as reduced final results (604). The system can provide a persistence service that stores and manages the data objects dynamically created by the analytic service, and that allows climate data server instances to be deployed as virtual climate data servers (606). The system can provide software that implements a data grid, wherein a plurality of climate data servers can be communicatively linked to form a federated data grid (608). The system can also provide a system interface that includes an adapter module that invokes climate data analytics system services by mapping service requests to specific operations in the system services suite, and a communications module that links the adapter module to external applications through a service request protocol based on the data flow categories of a long-term preservation digital archive reference model (610).

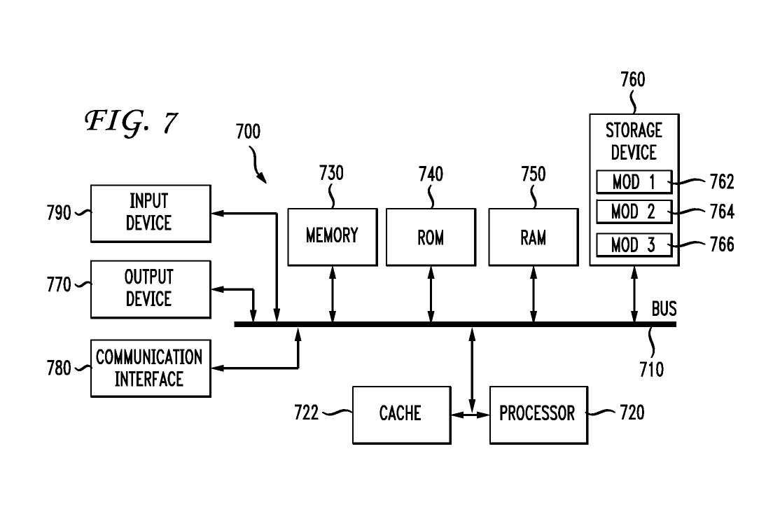

With reference to FIG. 7, an exemplary system and/or computing device 700 includes a processing unit (CPU or processor) 720 and a system bus 710 that couples various system components including the system memory 730 such as read only memory (ROM) 740 and random access memory (RAM) 750 to the processor 720. The system 700 can include a cache 722 of high-speed memory connected directly with, in close proximity to, or integrated as part of the processor 720. The system 700 copies data from the memory 730 and/or the storage device 760 to the cache 722 for quick access by the processor 720. In this way, the cache provides a performance boost that avoids processor 720 delays while waiting for data. These and other modules can control or be configured to control the processor 720 to perform various operations or actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the processor. The processor 720 may be a self-contained computing system, containing multiple cores or processors, a bus, memory controller, cache, etc. A multi-core processor may be symmetric or asymmetric. The processor 720 can include multiple processors, such as a system having multiple, physically separate processors in different sockets, or a system having multiple processor cores on a single physical chip. Similarly, the processor 720 can include multiple distributed processors located in multiple separate computing devices, but working together such as via a communications network. Multiple processors or processor cores can share resources such as memory 730 or the cache 722, or can operate using independent resources. The processor 720 can include one or more of a state machine, an application specific integrated circuit (ASIC), or a programmable gate array (PGA) including a field PGA.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 760 can include software modules 762, 764, 766 for controlling the processor 720. The system 700 can include other hardware or software modules. The storage device 760 is connected to the system bus 710 by a drive interface. The drives and the associated computer-readable storage devices provide nonvolatile storage of computer-readable instructions, data structures, program modules and other data for the computing device 700. In one aspect, a hardware module that performs a particular function includes the software component stored in a tangible computer-readable storage device in connection with the necessary hardware components, such as the processor 720, bus 710, display 770, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 700 is a small, handheld computing device, a desktop computer, or a computer server. When the processor 720 executes instructions to perform “operations”, the processor 720 can perform the operations directly and/or facilitate, direct, or cooperate with another device or component to perform the operations.

Although the exemplary embodiment(s) described herein employs the hard disk 760, other types of computer-readable storage devices which can store data that are accessible by a computer, such as magnetic cassettes, flash memory cards, digital versatile disks (DVDs), cartridges, random access memories (RAMs) 750, read only memory (ROM) 740, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general purpose processor. For example the functions of one or more processors presented in FIG. 7 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 740 for storing software performing the operations described below, and random access memory (RAM) 750 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 7 can practice all or part of the recited methods, can be a part of the recited systems, and/or can operate according to instructions in the recited tangible computer-readable storage devices. Such logical operations can be implemented as modules configured to control the processor 720 to perform particular functions according to the programming of the module. For example, FIG. 7 illustrates three modules Mod1 762, Mod2 764 and Mod3 766 which are modules configured to control the processor 720. These modules may be stored on the storage device 760 and loaded into RAM 750 or memory 730 at runtime or may be stored in other computer-readable memory locations.

One or more parts of the example computing device 700, up to and including the entire computing device 700, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 720 can include all types of processors disclosed herein, including a virtual processor. However, when referring to a virtual processor, the processor 720 includes the software components associated with executing the virtual processor in a virtualization layer and underlying hardware necessary to execute the virtualization layer. The system 700 can include a physical or virtual processor 720 that receive instructions stored in a computer-readable storage device, which cause the processor 720 to perform certain operations. When referring to a virtual processor 720, the system also includes the underlying physical hardware executing the virtual processor 720.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply generally to climate data sets, but can also be applied to other large data sets of non-climate data. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

We claim:

1. A system for providing climate data analytics as a service, the system comprising:
a high-performance data analytics platform comprising:
an assemblage of compute and storage nodes that provide a compute-storage fabric upon which high-performance analytic operations are performed over distributed collections of climate data;
a high-performance file system; and
a virtualizer that virtualizes the high-performance data analytics platform for customized deployment of the high-performance data analytics platform;
an analytic service comprising:
a first module that transforms multidimensional binary climate data encoded in a commonly used climate data file format to yield analysis files suitably formatted for high-performance analytic software input and output and loads the transformed files into the high-performance file system of the high-performance data analytics platform;
a second module that transforms analysis files stored in the high-performance data analytics platform to yield multidimensional binary files encoded in a commonly used climate data file format and moves the transformed files out of the high-performance file system of the high-performance data analytics platform; and
a third module comprising a plurality of software applications that implement the functions of the service by performing high-performance analytic operations over analysis files stored in the high-performance files system and collecting results into dynamically created data objects;
a persistence service comprising:
a climate data server that stores and manages the data objects dynamically created by the analytic service;
virtualization and provisioning software that allows climate data server instances to be deployed as virtual climate data servers; and
software that implements a data grid, wherein a plurality of climate data servers can be communicatively linked to form a federated data grid;
a system interface comprising:
an adapter module that invokes climate data analytics system services by mapping service requests to specific operations in the system services suite; and
a communications module that links the adapter module to external applications through a service request protocol based on the data flow categories of a long-term preservation digital archive reference model.

2. The system of claim 1, wherein the software applications that implement the functions of the service accept inputs comprising:
a name of a climate variable contained in a climate data set;
a spatial extent that specifies the area of interest for a climate variable;
a temporal extent that specifies the time span of interest for a climate variable; and
a plurality of additional parameters as needed by the software applications.

3. The system of claim 1, wherein the analytic service provides basic operations comprising:
a maximum operation that determines the maximum value of a climate variable over a specified spatial and temporal extent;
a minimum operation that determines the minimum value of a climate variable over a specified spatial and temporal extent;
a sum operation that determines the sum of the values of a climate variable over a specified spatial and temporal extent;
a count operation that determines the number of instances of a climate variable over a specified spatial and temporal extent;
an average operation that determines the arithmetic mean of a set of climate variables over a specified spatial and temporal extent;
a variance operation that determines the variance of the mean for a set of a climate variables over a specified spatial and temporal extent; and
a difference operation that determines the difference between two climate variables over a specified spatial and temporal extent.

4. The system of claim 3, wherein the basic operations can be extended to create additional capabilities.

5. The system of claim 1, wherein the climate data server further comprises:
software that performs data storage functions comprising collection-building, managing, querying, accessing, and preserving multidimensional binary climate data;
software that performs data management functions comprising applying policy-based control on the data objects stored and managed by the climate data server, logging object-level actions, and managing object-level metadata; and
software that performs metadata management functions by extracting the metadata associated with a climate data object and storing the metadata in the climate data server in accordance with the metadata standards of a long-term preservation digital archive reference model.

6. The system of claim 5, wherein the data storage functions further comprise:
a create operation that accepts as input an information package comprising a multidimensional binary data object and associated metadata, then stores the package in the climate data server;
a read operation that transfers an information package stored in the climate data server out of the climate data server;
an update operation that modifies an information package stored in the climate data server; and
a delete operation that removes an information package from the climate data server.

7. The system of claim 1, wherein the climate data server stores and manages multidimensional binary data objects from sources other than the analytic service of the climate data analytics system.

8. The system of claim 1, wherein the climate data server stores and manages data objects in a plurality of common climate data formats.

9. The system of claim 1, further comprising:
a discovery service wherein a software application provides information about the data objects that can potentially be dynamically generated by the analytic service, the resulting information being used as input in further interactions with the system.

10. The system of claim 9, wherein the discovery service further provides information about data objects stored in the persistence service, the resulting information being used as input in further interactions with the system.

11. The system of claim 1, further comprising:
a plurality of support services that transform analytic service data objects to yield data objects tailored to the specific requirements of the end user, the plurality of support services comprising:
a regridding service comprising software that transforms a data object from one climate grid resolution to yield a data object in a different climate grid resolution, the transformed object further being stored in the persistence service;
a downscaling service comprising software that transforms globally-relevant climate data objects to yield locally-relevant climate data objects, the transformed object further being stored by the persistence service;
an ontology service comprising software that performs ontological alignment over a plurality of data objects comprising a heterogeneous and semantically diverse assemblage of variable names, concepts, and metadata representations, the alignment information further being used in subsequent interactions with the system; and
a formatting service comprising software that transforms data objects in one file format to yield data objects in a different file format, the transformed objects further being stored in the persistence service.

12. The system of claim 11, wherein the plurality of support services can be extended to include additional services to meet end user requirements.
